(19) United States
(12) Patent Application Publication
(10) Pub. No.: US 2020/0265822 A1
(43) Pub. Date: Aug. 20, 2020

(54) ACTIVE HELMHOLTZ RESONATOR WITH ACTUATED MEMBRANE

(71) Applicant: Faurecia Emissions Control Technologies, USA, LLC, Coulmbus, IN (US)

(72) Inventors: James Egan, Indianapolis, IN (US); Matthias Berger, Columbus, IN (US); Joe Callahan, Greenwood, IN (US)

(21) Appl. No.: 16/275,635

(22) Filed: Feb. 14, 2019

(51) Int. Cl. G10K 11/172; F01N 1/02; G10K 11/16

(52) U.S. Cl. CPC G10K 11/172; F01N 1/023; G10K 2210/32272; G10K 2210/12822; G10K 2210/3226; G10K 11/161

(57) ABSTRACT

A vehicle exhaust component includes a body with an open inner cavity providing a fixed volume and a neck having one end associated with the fixed volume and an opposite end associated with an exhaust gas flow path. A flexible membrane separates the fixed volume into a first chamber and a second chamber. An actuator is used to vary a tension of the flexible membrane.

### BACKGROUND OF THE INVENTION

An exhaust system conducts hot exhaust gases generated by an engine through various exhaust components to reduce emissions, improve fuel economy, and control noise. Emerging powertrain technologies are requiring the industry to provide even more stringent noise reduction. The frequencies that need to be attenuated are being pushed to lower frequencies that have not previously been addressed. One traditional solution to attenuate such frequencies is to provide more internal volume; however, due to tight packaging constraints, the area required for such volume is not available. Another solution to attenuate these lower frequencies is to use valves; however, valves drive a higher back pressure at lower revolutions-per-minute, which can potentially affect fuel economy in an adverse manner. Further, the use of valves increases cost and can introduce noise vibration harshness (NVH) error states such as squeak, rattle, etc. As such, there is a need for unique acoustic solutions that are more efficient from a volume perspective and have less impact from a back pressure aspect.

### SUMMARY OF THE INVENTION

In one exemplary embodiment, a vehicle exhaust component includes a body with an open inner cavity providing a fixed volume, a neck having one end associated with the fixed volume and an opposite end associated with an exhaust gas flow path, and a flexible membrane separating the fixed volume into a first chamber and a second chamber. An actuator is used to vary a tension of the flexible membrane.

In another exemplary embodiment, a vehicle exhaust component includes a Helmholtz resonator having a fixed volume and a neck having one end associated with the fixed volume and an opposite end associated with an exhaust gas flow path. The neck has a fixed length and a fixed diameter such that the Helmholtz resonator has a first resonant frequency. A flexible membrane separates the fixed volume into a first chamber and a second chamber. The flexible member is configured to vibrate to provide a second resonant frequency. An actuator is used to change a tension of the flexible membrane to vary the second resonant frequency.

An exemplary method includes: providing a Helmholtz resonator with a first resonant frequency, the Helmholtz resonator having a fixed volume; separating the fixed volume into a first chamber and a second chamber with a flexible membrane to provide a second resonant frequency; and adjusting a tension of the flexible membrane to vary the second resonant frequency.

In a further embodiment of any of the above, the tension is adjusted by the actuator as a function of engine speed.

In a further embodiment of any of the above, the actuator includes a controller and microphone, and wherein the tension is adjusted in a closed loop based on input from the microphone.

In a further embodiment of any of the above, the actuator comprises a linear actuator.

In a further embodiment of any of the above, a frame fixes an outer peripheral edge of the flexible membrane relative to the body, a rigid ring is placed against the flexible membrane to define an active portion of the flexible membrane, and a connector is used to connect the actuator to the rigid ring.

In a further embodiment of any of the above, the actuator increases a force applied by the rigid ring against the flexible membrane to increase the tension of the active portion to increase a resonant frequency, and wherein the actuator decreases the force applied by the rigid ring against the flexible membrane to decrease the tension of the active portion to decrease the resonant frequency.

In a further embodiment of any of the above, a first frame is fixed within the fixed volume and a second frame is moveable relative to the first frame, and wherein an outer peripheral edge of the flexible membrane is clamped between the first and second frames leaving an open inner area that forms an active portion of the flexible membrane. The actuator compresses the outer peripheral edge between the first and second frames to decrease a resonant frequency of the active portion.

These and other features of this application will be best understood from the following specification and drawings, the following of which is a brief description.

### BRIEF DESCRIPTION OF THE DRAWINGS

FIG. 1 shows a traditional Helmholtz resonator.

FIG. 2 is a Helmholtz resonator that incorporates an actuated membrane according to the subject invention.

FIG. 3 is one example of an actuator for the membrane in a non-actuated state.

FIG. 4 is the actuator of FIG. 3 in an actuated state.

FIG. 5 is a top view of one example of a round membrane.

FIG. 6 is a perspective view of the membrane of FIG. 5.

FIG. 7 is a top view of one example of a polygonal membrane.

FIG. 8 is a top view of one example of an oval membrane.

FIG. 9 is another example of an actuator for the membrane in a non-actuated state.

FIG. 10 is the actuator of FIG. 9 in an actuated state.

FIG. 11 is a perspective view of a round membrane from FIG. 9.

FIG. 12 is an example of an open loop control system for the actuator.

FIG. 13 is an example of a closed loop control system for the actuator.

FIG. 14 is one example of the membrane being used in a coaxial resonator.

FIG. 15 is one example of the membrane being used in a muffler.

FIG. 16 is one example of the membrane being used in a three pass muffler.

FIG. 17 depicts an alternate actuator for the membrane

FIG. 18 is a graph showing transmission loss for four different resonator configurations.

### DETAILED DESCRIPTION

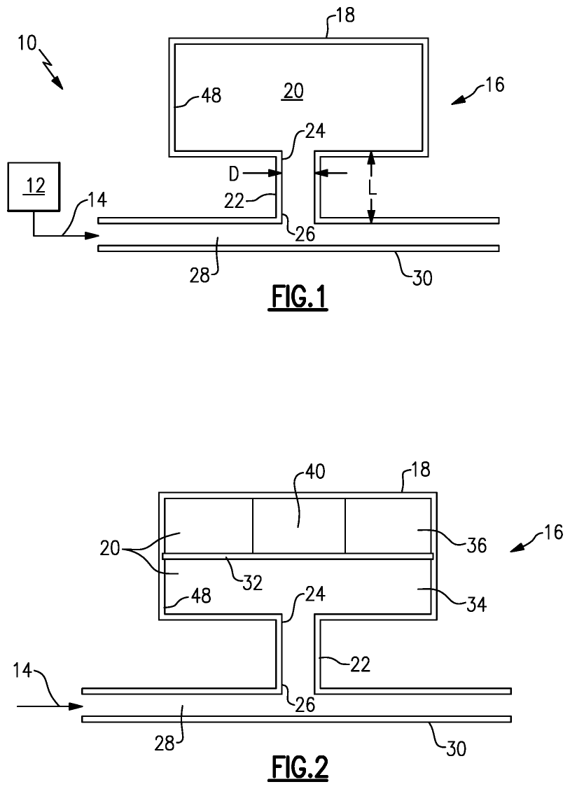

FIG. 1 shows a schematic representation of a vehicle exhaust system 10 that conducts hot exhaust gases 14 generated by an engine 12 through various exhaust components to reduce emission and control noise as known. The system 10 includes a noise attenuating device 16 that includes a body 18 with an open inner cavity providing a fixed volume 20 and a neck 22 that connects to the body 18. The neck 22 has one open end 24 associated with the fixed volume 20 and an opposite open end 26 associated with an exhaust gas flow path 28 that receives the exhaust gases 14. In the example shown in FIG. 1, the exhaust gas flow path 28 is defined within an exhaust tube or pipe 30.

The neck 22 has a fixed length L and diameter D, and this in combination with the fixed volume 20 forms a Helmholtz resonator, which has a unique resonant frequency. As shown in FIG. 2, the subject invention incorporates a flexible membrane 32 that splits the fixed volume 20 into a first or primary chamber 34 and a second or secondary chamber 36. The membrane 32 is configured to vibrate and introduces a second resonant frequency to the system 10. A tension of the membrane 32 is varied/adjusted by an actuator 40 to change the second resonant frequency. In one example, the actuator 40 is placed within the fixed volume 20 and is located in the second chamber 36.

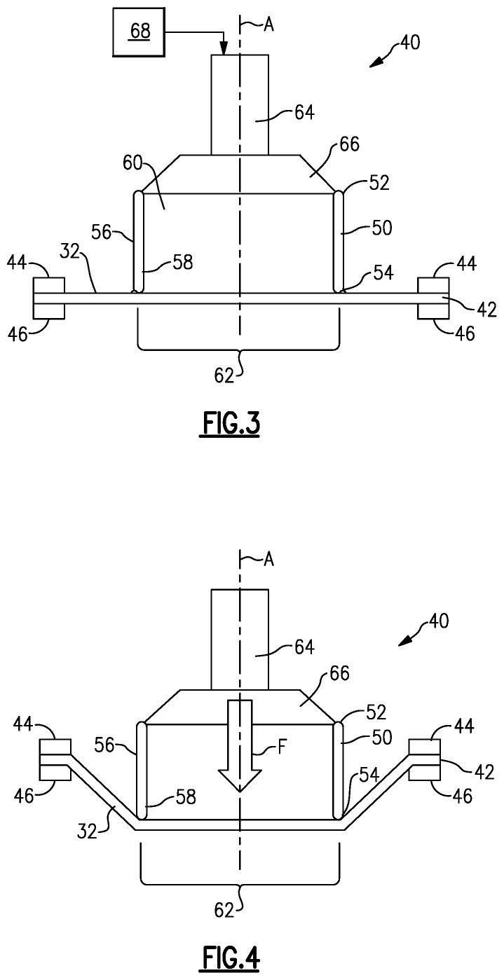

FIGS. 2-8 show one example of an actuator 40 for the flexible membrane 32. In this example, an outer peripheral edge 42 of the membrane 32 is supported by a first frame 44 and a second frame 46. The first 44 and second 46 frames are both fixed to the body 18 within the fixed volume 20. In one example, the first 44 and second 46 frames are directly fixed to an inner surface 48 (FIG. 2) of the body 18 with the first frame 44 located in the secondary chamber 36 and the second frame 46 located in the primary chamber 34. The outer peripheral edge 42 of the membrane 32 is clamped firmly between the first 44 and second 46 frames such that the edge 42 is held fixed relative to the body 18.

In one example, the second chamber 36 includes a rigid ring 50 that is placed directly against the membrane 32. The ring 50 extends between a first end 52 and a second end 54 and has an outer peripheral surface 56 that surrounds a center axis A of the ring 50. An inner peripheral surface 58 of the ring 50 defines an open inner area 60. The second end 54 of the ring 50 abuts directly against the membrane 32 such that the ring 50 circumscribes a disk on the membrane 32 that is defined as an active portion 62 of the membrane 32. This active portion 62 will vibrate and introduce the second resonant frequency.

The first end 52 of the ring 50 is linked to a moveable member 64 of the actuator 40 with a connecting element or connector 66 that can comprise a linkage, a sleeve, a cone, a cam, etc. or other similar coupling mechanism. In one example, the moveable member 64 comprises a linear actuator that is moveable along the axis A. The linear actuator can be pneumatic, hydraulic, or electric for example.

When the actuator 40 applies a force F to push the ring 50 against the membrane 32, the membrane 32 stretches and elastically deforms. As a result, the active portion 62 of the membrane 32 is put under increased tension, which increases its resonant frequency. When the actuator 40 moves in an opposite direction, the tension decreases and the membrane 32 returns to its initial position and the resonant frequency decreases. In one example, a controller 68 comprising an electronic control unit, for example, can be used to operate the moveable member 64 to adjust/vary the tension. The tension of the active portion 62 can thus be varied by the actuator 40 between multiple different resonant frequencies as needed. This will be discussed in greater detail below.

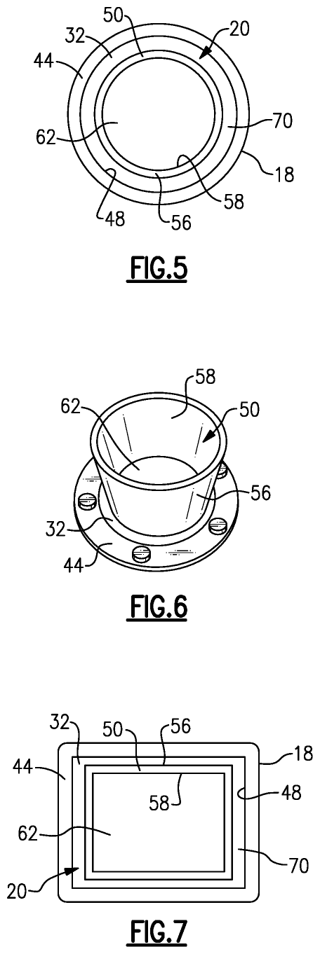

In one example, the shape of the frames 44, 46 and the ring 50 are designed to mimic the inner surface 48 of the body 18 that defines the shape of the fixed volume 20. As such, if the fixed volume 20 has a circular cross section, then the frames 44, 46 are circular and the ring 50 is circular. FIGS. 5-6 show an example of a circular fixed volume 20 and a circular ring 50. The ring 50 has a smaller diameter than the diameter that defines the inner surface 48 of the body 18. This leaves a gap 70 between the inner surface 48 and the outer peripheral surface 56 of the ring 50 to allow the ring 50 to move within the fixed volume 20.

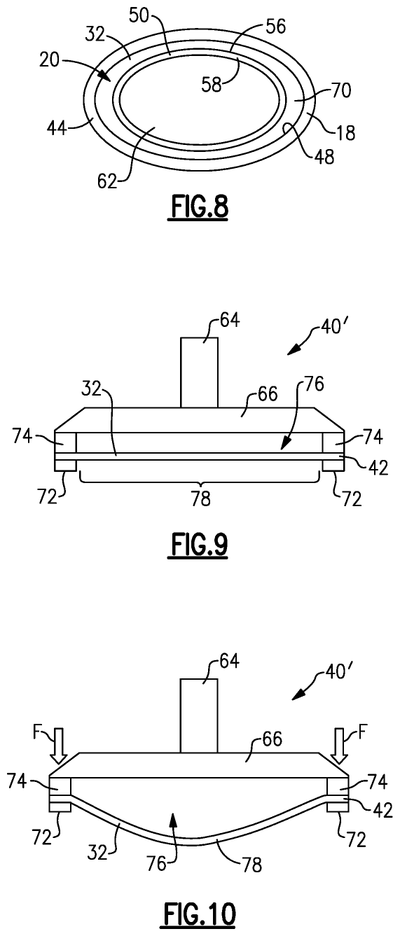

FIG. 7 shows an example where the body 18 and the fixed volume 20 have a polygonal cross section. The frames 44, 46 are therefore also polygonal as well as the ring 50. The ring 50 forms a smaller polygon than the fixed volume 20 which provides the gap 70 between the inner surface 48 of the body 18 and the outer peripheral surface 56 of the ring 50.

FIG. 8 shows an example where the body 18 and the fixed volume 20 have an oval cross section. The frames 44, 46 are therefore also oval as well as the ring 50. The ring 50 forms a smaller oval than the fixed volume 20 which provides the gap 70 between the inner surface 48 of the body 18 and the outer peripheral surface 56 of the ring 50.

By mimicking the shape of the ring 50 with the shape of the fixed volume 20, the active portion 62 of the membrane 32 is maximized which accordingly maximizes the attenuation of the resonator. Additionally, the ring 50 allows the active portion 62 of the membrane 32 to keep the same shape when actuated, which allows it to vibrate with efficient mode shapes and the amplitude of attenuation will not decrease when the frequency/tension increases.

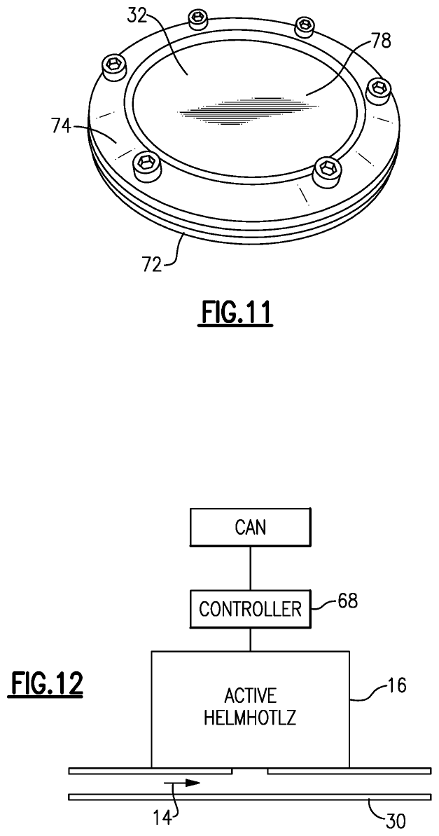

FIGS. 9-11 show another example of an actuator 40′ for the flexible membrane 32. In this example, the outer peripheral edge 42 of the membrane 32 is supported by a first frame 72 that is fixed to the body 18 within the fixed volume 20. A second frame 74 is configured to be moveable relative to the first frame 72. In one example, the first frame 72 is directly fixed to the inner surface 48 of the body 18 with the first frame 72 being located in the first chamber 34. The outer peripheral edge 42 of the membrane 32 is clamped between the first 72 and second 74 frames, which leaves an open inner area 76. The open inner area 76 defines an active portion 78 of the membrane 32. The shape of the frames 72, 74 and of the active portion 78 are made to mimic the cross section of the fixed volume 20 for the same reasons as discussed above. FIG. 11 shows an example of a round configuration.

In the example of FIGS. 9-11, the first frame 72 is fixed within the fixed volume 20 and the second frame 74 is able to move in an axial direction along the axis A relative to the first frame 72. One end of the second frame 74 is linked to the moveable member 64 of the actuator 40′ with the connecting element or connector 66. The connector 66 and moveable member 64 are as described above. When the moveable member 64 applies a force F to move the second frame 74 toward the first frame 72, it closes the gap between the frames 72, 74 and compresses the outer peripheral edge 42 of the membrane 32 between the frames 72, 74. As the clamped edge 42 is compressed, membrane material deforms and moves to the active portion 78 of the membrane 32, which relaxes the active portion 78. When the active portion 78 membrane is relaxed it's resonant frequency decreases. When the pressure on the edge 42 is released by moving the second frame 74 in the opposite direction, the membrane 32 returns to its initial state with increased tension to provide an increase in the resonant frequency. In one example, the flexible membrane 32 can be initially clamped under tension to increase the range of possible relaxation.

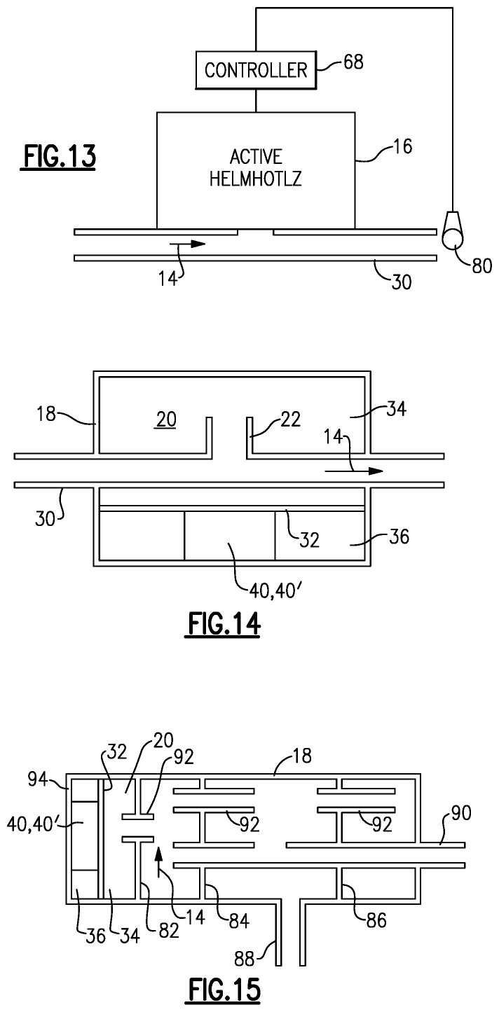

With each example of the actuator 40, 40′, the stroke of the moveable member 64 could be adjusted on an open-loop basis as a function of engine speed (see FIG. 12). A controller area network (CAN) cooperates with the controller 68 to communicate engine speed data as known. The tension of the active portion 62, 78 of the membrane 32 can therefore be actively adjusted/varied by the controller 68 and moveable member 64 during vehicle operation to meet noise attenuating requirements.

In another example, the stroke of each actuator 40, 40′ could be adjusted on a closed loop basis using an error microphone 80 and controller 68 as shown in FIG. 13. The tension of the active portion 62, 78 of the membrane 32 can therefore be actively and continuously adjusted/varied by the controller 68 and moveable member 64 during vehicle operation in response to signals from the microphone 80 to meet noise attenuating requirements.

In one example, the invention is embodied as a side branch resonator as shown in FIG. 2. The invention can also be embodied as a coaxial resonator as shown in FIG. 14. In this example, the pipe 30 extends through the body 18 and is positioned in the first chamber 34. The actuator 40, 40′ is located in the second chamber 36.

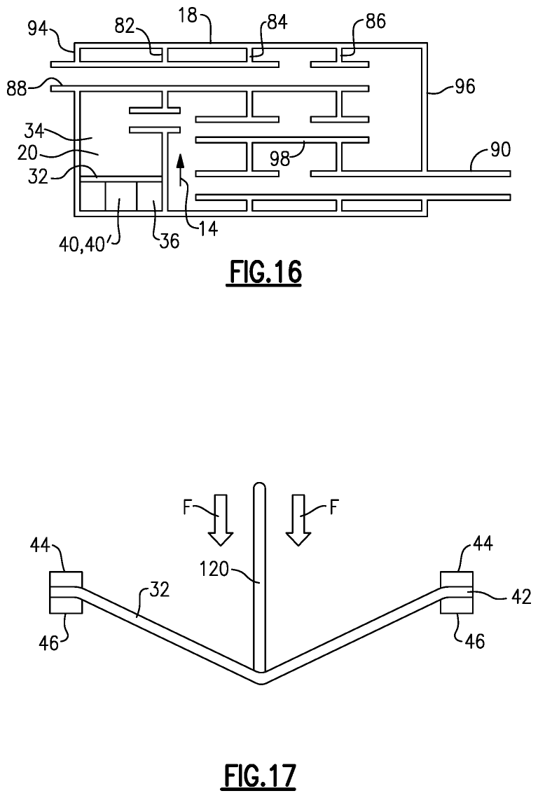

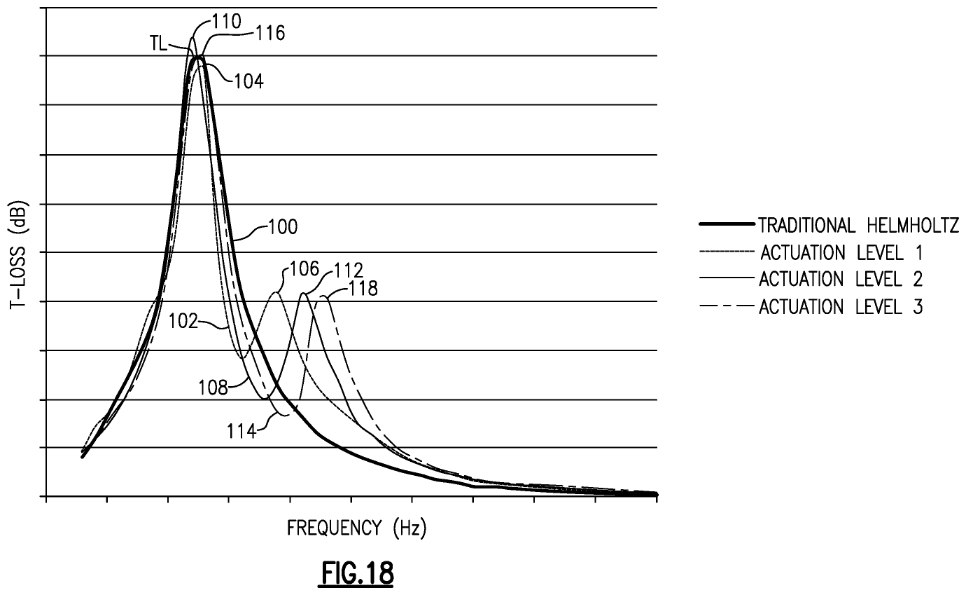

The invention can also be embodied as an in-muffler resonator as shown in FIGS. 15-16. In each of these examples, the membrane 32 is adapted to the most convenient cross-section of the resonator fixed volume 20. In the example of FIG. 15, the body 18 comprises a muffler housing that includes a first baffle 82, a second baffle 84, and a third baffle 86. The muffler includes an inlet pipe 88 and an outlet pipe 90 that extends through the second 84 and third 86 baffles. The second 84 and third 86 baffles each include a pipe portion 92 that extends between adjacent chambers. In one example, the neck 22 is formed in the first baffle 82 to define the resonator fixed volume 20 between the first baffle 82 and an enclosed end 94 of the muffler. The membrane 32 separates the fixed volume 20 into the primary chamber 34 and the secondary chamber 36. The actuator 40, 40′ is located in the second chamber 36.

In the example of FIG. 16, the muffler is a three pass muffler. The inlet pipe 88 extends through the end 94 of the muffler and through the first 82, second 84, and third 86 baffles. The outlet pipe 90 extends through the second 84 and third 86 baffles and out an opposite end 96 of the muffler. An additional pipe 98 extends through the second 84 and third 86 baffles. The pipe 98 is open to a chamber formed between the first 82 and second 84 baffles, to a chamber formed between the second 84 and third 86 baffles, and to a chamber formed between the third baffle 86 and the end 96 of the muffler. In one example, the neck 22 is formed in the first baffle 82 to define the resonator fixed volume 20 between the first baffle 82 and the end 94 of the muffler. The membrane 32 separates the fixed volume 20 into the primary chamber 34 and the secondary chamber 36. The actuator 40, 40′ is located in the second chamber 36.

FIG. 17 shows an alternative way to actuate the member 32. In this example, the edge 42 of the membrane 32 is fixed between two fixed frames 44, 46. An actuation rod 120 coupled to a linear actuator is directly applied against a center of the membrane 32. The linear actuator extends the rod 120 to deform the shape of membrane 32, which in turn increases the second resonant frequency. This actuation method provides for a less complex more cost effective design; however, while the other actuation methods described above using actuators 40, 40′ are more complex, they provide for significantly improved performance over the configuration of FIG. 17.

FIG. 17 compares results from transmission loss (TL) for three different actuation levels of a resonator with a membrane as compared to a traditional Helmholtz resonator. FIG. 17 comprises a graph of TL in decibels vs. frequency (Hertz). A traditional Helmholtz resonator with a fixed neck and fixed volume is shown at curve 100. This is a typical curve with a very distinct TL peak.

In an example where the resonator includes a passive, e.g. non-active, membrane, a curve 102 includes a first peak 104 with a first resonant frequency and a second peak 106 with a second resonant frequency. The first peak 104 is generally at the same frequency but at a lower decibel level than the TL peak. The second peak 106 is at a higher frequency than the first peak 104.

In an example where the resonator includes an active membrane such as that of the subject invention, a curve 108 includes a first peak 110 with a first resonant frequency and a second peak 112 with a second resonant frequency. In this example, the membrane is actuated by a first amount of deflection. In this example, the second peak 112 shifts to a higher frequency than the frequency of the second peak 106 of the passive curve 102.

In another example where the resonator includes an active membrane such as that of the subject invention, a curve 114 includes a first peak 116 with a first resonant frequency and a second peak 118 with a second resonant frequency. In this example, the membrane is actuated with a second amount of deflection that is greater than the first amount of deflection. In this example, the second peak 118 shifts to an even higher frequency.

Thus, this graph shows a significant shift of the TL peak when actuating the membrane 32.

The subject invention provides a flexible membrane 32 with an active portion 62, 78 whose tension is controlled by an actuator 40, 40′ to introduce a variable second resonant frequency to a Helmholtz resonator. By using the subject actuators 40, 40′ the transmission loss peak for the second frequency can be shifted to higher frequencies to increase the range of attenuation. Optionally, the second frequency can be shifted to lower frequencies if needed.

Although an embodiment of this invention has been disclosed, a worker of ordinary skill in this art would recognize that certain modifications would come within the scope of this invention. For that reason, the following claims should be studied to determine the true scope and content of this invention.

1. A vehicle exhaust component comprising:
a body with an open inner cavity providing a fixed volume;
a neck having one end associated with the fixed volume and an opposite end associated with an exhaust gas flow path;
a flexible membrane separating the fixed volume into a first chamber and a second chamber; and
an actuator to vary a tension of the flexible membrane.

2. The vehicle exhaust component according to claim 1, wherein the neck has a fixed length and a fixed diameter.

3. The vehicle exhaust component according to claim 1, wherein the body and neck form a Helmholtz resonator.

4. The vehicle exhaust component according to claim 1, wherein the flexible membrane, body, and neck cooperate to define a first resonant frequency and a second resonant frequency, and wherein the actuator adjusts the tension of an active portion of the flexible member to vary the second resonant frequency.

5. The vehicle exhaust component according to claim 1, wherein the tension is adjusted by the actuator as a function of engine speed.

6. The vehicle exhaust component according to claim 1, wherein the actuator includes a controller and microphone, and wherein the tension is adjusted in a closed loop based on input from the microphone.

7. The vehicle exhaust component according to claim 1, wherein the fixed volume has a first cross-sectional shape, and wherein an active portion of the flexible membrane has a second cross-sectional shape that is the same as the first cross-sectional shape.

8. The vehicle exhaust component according to claim 1, wherein the actuator comprises a linear actuator.

9. The vehicle exhaust component according to claim 1, wherein the neck connects the body to an exhaust pipe that provides the exhaust gas flow path to form a side branch resonator.

10. The vehicle exhaust component according to claim 1, wherein the body comprises a muffler with an interior that includes the neck and fixed volume.

11. The vehicle exhaust component according to claim 1, including a frame that fixes an outer peripheral edge of the flexible membrane relative to the body, a rigid ring placed against the flexible membrane to define an active portion of the flexible membrane, and a connector to connect the actuator to the rigid ring.

12. The vehicle exhaust component according to claim 11, wherein the actuator increases a force applied by the rigid ring against the flexible membrane to increase the tension of the active portion to increase a resonant frequency, and wherein the actuator decreases the force applied by the rigid ring against the flexible membrane to decrease the tension of the active portion to decrease the resonant frequency.

13. The vehicle exhaust component according to claim 1, including a first frame fixed within the fixed volume and a second frame that is moveable relative to the first frame, and wherein an outer peripheral edge of the flexible membrane is clamped between the first and second frames leaving an open inner area that forms an active portion of the flexible membrane, and wherein the actuator compresses the outer peripheral edge between the first and second frames to decrease a resonant frequency of the active portion.

14. A vehicle exhaust component comprising:
a Helmholtz resonator having a fixed volume and a neck having one end associated with the fixed volume and an opposite end associated with an exhaust gas flow path, and wherein the neck has a fixed length and a fixed diameter such that the Helmholtz resonator has a first resonant frequency;
a flexible membrane separating the fixed volume into a first chamber and a second chamber, and wherein the flexible member is configured to vibrate to provide a second resonant frequency; and
an actuator to change a tension of the flexible membrane to vary the second resonant frequency.

15. The vehicle exhaust component according to claim 14, wherein the actuator comprises a linear actuator, and wherein the tension is adjusted by the actuator as a function of engine speed, and wherein the actuator includes a controller and microphone, and wherein the tension is adjusted in a closed loop based on input from the microphone.

16. The vehicle exhaust component according to claim 14, including a fixed frame that supports an outer peripheral edge of the flexible membrane relative to the Helmholtz resonator.

17. The vehicle exhaust component according to claim 16, including a second frame that is moveable relative to the fixed frame, and wherein the outer peripheral edge of the flexible membrane is clamped between the fixed and second frames leaving an open inner area that forms an active portion of the flexible membrane, and wherein the actuator compresses the outer peripheral edge between the fixed and second frames to decrease a resonant frequency of the active portion.

18. The vehicle exhaust component according to claim 16, wherein the fixed frame holds the outer peripheral edge fixed relative to the Helmholtz resonator, and including
a rigid ring placed against the flexible membrane to define an active portion of the flexible membrane, and
a connector to connect the actuator to the rigid ring, and wherein the actuator increases a force applied by the rigid ring against the flexible membrane to increase the tension of the active portion to increase a resonant frequency, and wherein the actuator decreases the force applied by the rigid ring against the flexible membrane to decrease the tension of the active portion to decrease the resonant frequency.

19. A method comprising:
providing a Helmholtz resonator with a first resonant frequency, the Helmholtz resonator having a fixed volume;
separating the fixed volume into a first chamber and a second chamber with a flexible membrane to provide a second resonant frequency; and
adjusting a tension of the flexible membrane to vary the second resonant frequency.

20. The method according to claim 19, wherein the tension is adjusted
in an open loop as a function of engine speed, or
in a closed loop via a controller based on input from a microphone.
